(19) United States
(12) Patent Application Publication
(10) Pub. No.: US 2003/0069848 A1
(43) Pub. Date: Apr. 10, 2003

(54) A User interface for computer network management

(76) Inventors: Daniel S. Larson, Chesterfield, MO (US); Paul Yung-Pu Ke, Chesterfield, MO (US); Eric J. Nilsen, Manchester, MO (US); Ronald E. Zika JR., Columbia, IL (US); Timothy W. Davis, St. Louis, MO (US)

Correspondence Address: Evan R. Sotiriou, Harness, Dickey & Pierce, P.L.C., Suite 700, 7700 Bonhomme, St. Louis, MO, 63105, US

(21) Appl. No.: 09/828,702

(22) Filed: Apr. 6, 2001

(51) Int. Cl. G06F 17/60; H04K 1/00; H04L 9/00

(52) U.S. Cl. 705/50

(57) ABSTRACT

A user interface is for controlling a computer network. The user interface comprises a device menu, a device selection identifier, function menus, a function selection identifier, and a results screen. The device menu identifies at least some of the devices that comprise the computer network. The device selection identifier provides for selecting one of the devices. The function menus correspond to the devices and identify at least some functions that can be performed in connection with the devices. The function selection identifier corresponds to the function menus that allow an entity to select one of the functions. The user may select one of the devices, and may select one of the functions corresponding to the device that is selected. The results screen displays a result corresponding to a selected function. The user interface can be used in connection with wireless devices or an existing network management systems.

### FIELD OF THE INVENTION

This invention relates to computer network management and, more specifically, to a method and system for managing such a network with a menu driven diagnosis and problem solving interface in conjunction with wireless devices.

### BACKGROUND OF THE INVENTION

We live in a day and age, and have for some time, in which computers and their networking dominate the success or failure of businesses, large and small. Successful computer networking brings together corporations, their employees and clients to enjoy more productive and efficient relationships. The United States economy has experienced a significant boom, based in large part, on the efficiencies created by large-scale computer networking, integration, and the software-based applications that operate on the network. Profit margins have increased as industry has become more efficient.

Our reliance, however, comes at a price. Businesses have become so dependent on their computer systems and related technologies that downtime for all or part of a computer network can bring a business to a screeching halt. Typically, the result is revenue loss and, often times, consumer service interruption and loss of consumer goodwill. Minutes of downtime can result in millions in lost revenue. Longer delays can lead to extraordinary losses.

Recognizing the seriousness of the situation, most corporations maintain an information technology (IT) staff. The staff is charged with making sure the computer network remains operational. It is nonetheless common for computer networks to go down during business hours when the IT professional responsible for the network is not at a terminal where diagnosis and adjustments to the network are possible. This is certainly true in larger corporations where the IT professional visits multiple sites and is often times in between locations. It is also quite common for computer networks to go down after business hours or during lunch breaks.

There are network management systems (NMS systems) that automatically monitor computer networks. Examples of such systems are Hewlett Packard's OpenView and IBM's Tivoli. These systems are designed to monitor a number of computer network parameters (e.g., uptime of a device or the switch state of a router). NMS systems are also typically configurable to allow the end user to construct custom applications for monitoring the computer network and the devices making up the network. These systems do not, however, allow the IT professional to fix computer problems and certainly not from remote locations.

The NMS systems are also typically designed to set traps when particular conditions occur (e.g., a server goes down or an attack on the firewall). The NMS systems are equipped to send alerts to the IT professional via an e-mail or message to a pager. Many alerts require immediate attention. In such circumstances, the IT professional must go to a terminal in the computer network to address the problem or, in a remote situation, find access to the Internet and connect a laptop to the web and engage in a Telnet session to fix the problem. If the IT professional is at home, or worse, in bed, the professional is required to go to the office or connect to the network with remote access. While most problems will ultimately be fixed, current methods for addressing such problems are not ideally efficient. With minutes of downtime correlating to millions in damage, to use an old phrase, “every second counts.”

We live, and have for some time, in an era in which wireless devices put us in touch in seconds with others in remote locations. Examples of such devices are obvious and include, cellular telephones, personal digital assistants (PDAs), and beepers with digital readout screens. Yet, such devices have not been used, to date, to allow IT professionals to remotely monitor and fix computer networks. The primary reasons is that the level of communication between the remote device or terminal and the computer network is sufficiently significant such that it would be cumbersome to view using the small screen available on such devices and prohibitively slow due to bandwidth constraints.

Moreover, even as to existing connections that are made remotely to the computer network, most Telnet sessions that are necessary to monitor and fix computer network problems are characterized by unnecessarily complicated communications between the remote device or terminal and the computer network. Prior systems and methods for monitoring and fixing computer networks do not offer streamlined interfaces to facilitate quick diagnosis and treatment of the computer network problem.

### SUMMARY OF THE INVENTION

A user interface is provided for controlling a computer network. The user interface comprises a device menu, a device selection identifier, function menus, a function selection identifier, and a results screen. The device menu identifies at least some of the devices that comprise the computer network. The device selection identifier allows a user to select one of the devices. The function menus correspond to the devices and identify at least some functions that can be performed in connection with the devices. The function selection identifier corresponds to the function menus that allow the entity to select one of the functions. The user is able to select one of the devices comprising the computer network and is able to select one of the functions corresponding to the device that is selected. The result screen displays a result corresponding to the function that is selected by the user. In preferred embodiments the devices comprise network routers and servers, and can include any other hardware or software upon which network management functions are desirable. Also, in the preferred embodiment, typical functions can include statistics, device management functions, reboot/shutdown, and an activity log.

In a preferred embodiment, the user interface is used in conjunction with wireless devices. A method for implementing this embodiment comprises generating an action signal from a wireless device. The action signal corresponds to a desired network management action to be performed in connection with the computer network. The method further includes sending the action signal to the computer network and processing the action signal. The method also includes performing the desired network management action on the computer network. Further, the method preferably includes obtaining a result pertaining to the desired network management action and sending the result to the wireless device.

In a more preferred aspect of the method and system of the present invention, a security clearance procedure is performed prior to sending the action signal to ensure that the desired network management action is authorized. The security clearance procedure can comprise sending a password from the wireless device to the computer network and verifying that the password corresponds to an authorized entity. The method can also include encrypting the signal and password prior to sending the signal and password and decrypting the signal and password at the computer network. In another preferred aspect of the present invention, the password is corresponded to a predefined set of authorized actions that an entity is authorized to perform on the computer network and the entity is only allowed to perform the authorized actions. The authorized set of actions is typically less than a total number of actions that can be performed on the computer network.

The present invention therefore overcomes problems associated with the prior art. The simplified user interface allows most network management on most computer network devices to be readily performed. Further, the user interface significantly reduces information transmitted between the information technology professional and the network device, thus rendering the user interface ideal for wireless network management. Finally, the user interface is adapted to work in conjunction with existing network management systems (NMS). Thus, alerts generated by the NMS system can be transmitted to the user (to a wireless device or terminal). The user interface allows the user to readily view the alert and take corrective action.

These and other aspects of the invention are more fully described below.

### BRIEF DESCRIPTION OF THE DRAWINGS

FIG. 1 is a network diagram illustrating a preferred embodiment of the invention in which the network management system and method is used in conjunction with wireless devices.

FIG. 2 is an activity diagram illustrating the general flow of the menu system interface.

FIG. 3 is a deployment diagram illustrating the interface between the application server, the wireless devices, external network management systems (NMS), and the network devices over which the system and method of the present invention provides control.

FIG. 4 is a sequence diagram that reflects the method by which a user implements the network management menu system of the present invention and how the application server and its modules implement the action chosen by the user.

FIG. 5 is a class diagram that further illustrates the modules of the application server.

FIG. 6 is a sequence diagram that illustrates the present invention operating in conjunction with a network management system (NMS).

### DETAILED DESCRIPTION OF THE PREFERRED EMBODIMENTS

The present invention is directed to a network management system and a method of managing a computer network. Specifically, it is directed to a menu driven system that streamlines existing, more cumbersome interfaces, such as Telnet, to facilitate gathering information about a network and taking corrective action to fix or maintain it. The menu-driven system also renders possible the ability to perform network management via wireless devices from locations remote to the computer network.

As used herein, the term computer network is defined broadly to include those components that comprise computer systems that are used by businesses, large and small. Examples include servers (software and hardware), routers, switches, software applications, and database storage. The present invention is also adapted to work in connection with network management systems (NMS systems) such as Hewlett Packard's OpenView and IBM's Tivoli. Such systems are well known in the art and are typically resident on a computer network server. The software is adapted to monitor parameters from various computer network components to provide data regarding component performance and statistics. The software is also adapted to set traps and send alerts in the event that important thresholds or events occur. It is known, for example, to send an alert to a remote pager in the event that a server crashes or some other condition occurs imperative to the network's performance. Once alerted, however, an information technology (IT) professional is not enabled by the prior art or existing technology to remotely diagnose the problem and solve it with a wireless device from a remote location. Further, the prior art has not provided a menu driven user interface that greatly facilitates diagnosing and solving problems.

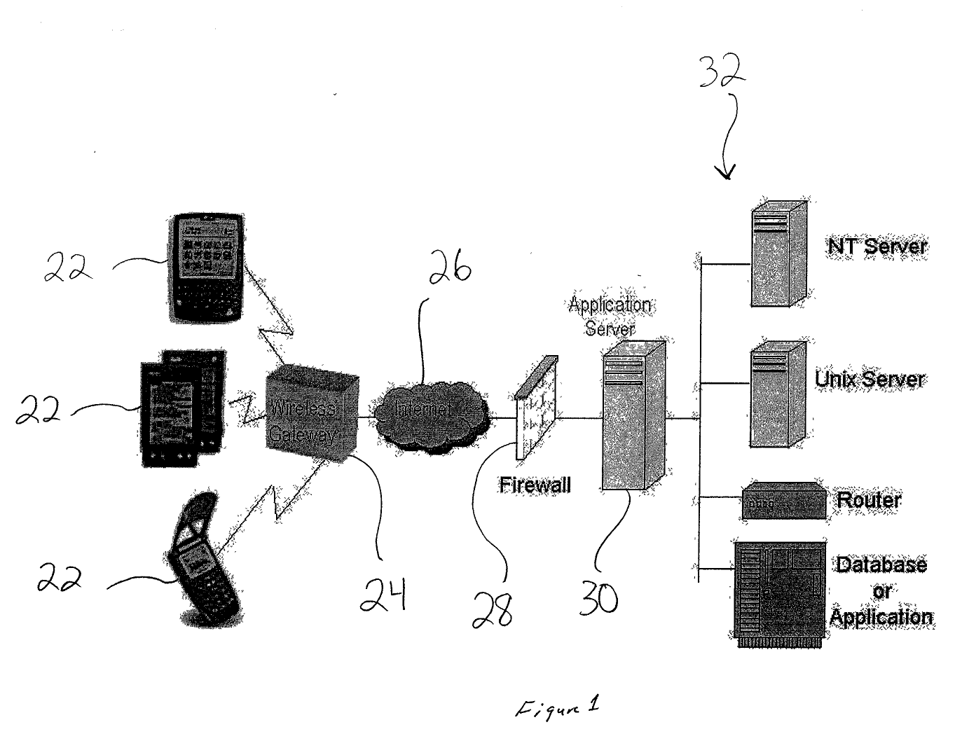

An overview of the present invention is shown in FIG. 1. Wireless devices 22 (e.g., a two-way pager, personal data assistant (PDA), or a cellular telephone) are adapted to connect to the Internet 26 via a wireless application protocol (WAP) gateway 24. A firewall 28 is resident on an application server 30 and ensures secure communications between the wireless device 22 and the computer network, generally designated 32. The application server 30 enables the interface between the wireless device 22 and the computer network, as described in detail below. The application server 30, when activated, causes a menu driven system (described below) to be displayed on the wireless device 22. The description that follows will begin by explaining a sample menu system and follows with an explanation of the software and methodology necessary to enable the menu system.

To put the present invention into perspective, it is first important to explain the manner in which most hardware and software are monitored and controlled from remote locations. An IT professional typically uses a computer workstation and accesses the desired hardware or network by initiating a Telnet session. Other network devices can be tested by pinging the device. Those skilled in the art readily appreciate and understand the known techniques for communicating with network devices to perform monitoring and problem solving, the most common of which, again, is Telnet. Turning back to the invention, the professional is required to designate an Internet protocol (IP) address or name corresponding to the hardware or network. The Telnet session will request a user ID and password. As used herein, password means a unique user identification, such as traditional word and/or number passwords, DNA, or fingerprint recognition. As is well known, Telnet sessions are cumbersome. In the first instance, the screens on wireless devices are not sized to accommodate the amount of information transmitted in a typical Telnet session. Further, the bandwidth required to transmit the information also renders standard Telnet sessions on wireless devices impractical.

In one aspect of the present invention, a menu driven interface is provided to simplify the Telnet session to decrease the information transmitted during the session to that necessary to monitor, diagnose and/or fix the computer network. The interface therefore overcomes existing bandwidth problems and facilitates using wireless devices to maintain a computer network from remote locations.

In a preferred embodiment, an exemplary menu system is described. Because each network is comprised of different hardware and software components, a customized menu system will be provided for each network, as is readily understood and implemented by one skilled in the art in conjunction with the description that follows. The described menu system will closely approximate the overall architecture and flow common to most applications.

In conjunction with wireless devices, the wireless device will preferably have an icon to launch the network management program. The first screen will prompt the user for a password or PIN number to ensure that the person holding the wireless device is authorized to access the computer network. This latter safeguard is particularly important in the event that the wireless device is lost. The screen preferably appears as follows:

Title Information
PIN_{——————}

| | |
|---|---|
| OK | EXIT |

The “Title Information” could be anything, including a customizable field for the company name to personalize the application to the company that owns the computer network, or it could be the name of the network management product with contact information, or some other introductory information as desired. The pin number can be any number of characters to ensure a desirable security level. The software should cause the entered characters to be displayed as stars or similar characters to prevent an onlooker from viewing the PIN number, as is well known in the art. The “OK” icon allows the PIN to be accepted when completed and the “EXIT” allows the user to exit the program in the event the program icon has been accidentally activated or in the event the user otherwise determines that he or she no longer wishes to enter the program.

Further, in the preferred embodiment, the PIN number will be correlated to a particular user group. Thus, for larger IT departments, different sets of privileges can be assigned to particular groups or individuals. Thus, the head of the IT department will be accorded full privileges, where lower level personnel might be afforded fewer privileges (e.g., preventing such personnel from re-booting the server).

After logging on to the system, the user is preferably greeted with the following screen:

Main Menu

1. Current Alerts [#]
2. Current Bulletins [#]
3. Network Management
4. Oracle Management
5. Activity Log
6. My Profile

| | |
|---|---|
| HELP | BACK |

In the preferred embodiment corresponding to a common computer network environment, the Main Menu presents the user with six primary options, as shown above. Alerts are desirably placed at the top of the list because they typically are triggered by equipment malfunctions or similar critical events. In the event that the alert is sent to the wireless device via an integrated NMS system, the alerts can be received in any format, but preferably XML. By selecting the appropriate icon, a subsequent screen is retrieved from the application server 30, as described below. The “[#]” symbol behind the “alerts” and “bulletins” icons indicates the number of alerts or bulletins that are listed. The “HELP” icon retrieves a sample screen with explanations of how to navigate the interface. The “BACK” icon returns the user to the previous screen. The icon could be replaced with an arrow pointing to the left, as is typical in many software applications.

By selecting the “Current Alerts” icon, a screen such as the following will be retrieved:

1/6/01 18:53 [ARSRVCE NIC]—still having problems w/ ARSRVCE—it only operates at 10 mb.

1/6/01 12:17 [ARSRWWW2]—FTP service not responding BACK

The alerts reflect the date and time of the alert. The alert also reflects the device name within the network (in the brackets). The alert also provides information regarding the problem with the device. The bullet points in the left margin can be a box symbol that can be “checked” to show that the alert has been addressed. The “checking” action is preferably transmitted to the application server so that it is updated to reflect this in the event other technicians access the network management system. Further, to the extent that more alerts are present than screen space, many wireless devices, primarily personal data assistants (PDAs), provide a scroll bar in the margin that allows the user to scroll up and down. Such a scrolling function is desirable.

By selecting the “Current Bulletins” icon, a screen such as the following will be retrieved:

Jan. 06, 2001 [REZ]
Can anybody cover on-call duties Saturday night, Mike has a wedding
Jan. 06, 2001 [GLH]
We will begin upgrading the firmware on all Bldg. 51 hubs starting
Saturday night Jan. 9, 2001. Should complete by 6 am.

The screen depicts two bulletins with the date of the bulletin. Bulletins are general messages to all users, informing them of system-wide conditions and notifications. Examples of such conditions and notifications could include: a cable topology segment outage, the estimated time until a problem resolution, the allocation of technicians to certain tasks, reminders of scheduled events, etc. This bulletin feature allows a degree of communication and collaboration common among the technical staff, and thereby enhancing the efficiency of technical operations. Bulletins can be added and removed at will at any time. The brackets enclose the initials of the person posting the bulletin. The short message that follows reflects the information of the bulletin.

By selecting the “Network Management” icon, a screen such as the following will be retrieved:

NT Server Admin
Unix Server Admin
Router Management
Find Device

. . . Submit

| | |
|---|---|
| HELP | BACK |

The listed icons provide the primary computer network components that are typically present. An IT professional is able to access a device not covered by the three listed categories (i.e., NT Server Admin, Unix Server Admin, or Router Management) by providing a device name. The “Submit” icon submits the request to locate a device by name or IP address.

By selecting the “NT Server” icon, a screen such as the following will be retrieved:

Server Groups

SQL Servers
WWW Servers
File Servers
Print Servers
Find Device

. . . Submit

BACK

Four primary server groups are identified. Again, in the event a particular server is not covered under the group headings and corresponding drop down menus under each group, a “Find Device” request can be made with the server name or IP address. To further illustrate the menu system, if the “WWW Servers” icon is selected, the following drop down menu will appear:

WWW Servers
ARSRVWWW1
ARSRVWWW2
ARSRVWWW3
ARSRVWWW4
NT Groups

The title at the top designates that the user is at the screen for WWW Servers and the title at the bottom indicates that the screen is a drop down menu from the NT Group. If a particular “WWW Server” is selected (e.g., “ARSRVWWW2), the following menu will appear:

ARSRVWWW2

Show Statistics
Manage Services
Reboot/Shut Down
Activity Log

NT Groups

BACK

The above functions are fairly self-explanatory, but sample screens are shown below for each. Below is a screen for the “Statistics” icon:

ARSRVWWW2

Memory

Hard Drive: 2,123,205,120 bytes; 1.97 GB
Ram: 103,000 kb; 100 mb

Server Name: ARSRVWWW2
Uptime: 45 days, 15:04:45

BACK

Below is a screen for typical services provided under the “Manage Services” icon:

ARSRVWWW2

PC Anywhere
FTP Service
WWW Service
MS Exchange
MS SQL Server

NT Group

BACK

Below is a screen for the “FTP Service” icon, which is a subhead for the “Manage Services” icon immediately above:

ARSRVWWW2

FTP Server
Status: Running
Restart Service
Stop Service

BACK

The “Restart Service” and “Stop Service” are icons that will initiate the corresponding action to the FTP Server. The “Status” line, as shown, indicates that the FTP Server is running. This information is transferred in real-time from the application server 30 to the wireless device 22.

The following is a sample screen for the “Reboot/Shut Down” icon:

ARSRVWWW2

Status: Running
Reboot
Shut Down

Type “Yes to Confirm:
. . . Submit

BACK

At this screen, selecting the icons “Reboot” or “Shut Down” will serve to highlight the selection. Because the chosen action (unlike simply checking a statistic) will result in a significant network activity, “yes” must be typed on the blank provided and the “Submit” icon selected. This sequence ensures that the server is not accidentally rebooted or shut down.

A screen corresponding to the “Activity Log” is shown below:

ARSRVWWW2

Activity Log
Jan. 06, 2001-18:53-SRV Restart-FTP Service-M. Burns
Jan. 06, 2001-14:43-SRV Restart-PC Anywhere-J. Livingston
Jan. 05, 2001-14:05-SRV Stop-MS Exchange-M. Burns
Jan. 04, 2001-10:23-SRV Stop-WWW Service-J. Livingston

Because this screen will normally include a long list, it is beneficial to use a wireless device that provides a scroll function. Further, to ensure that the amount of transmitted data is limited, it is preferred to adjust the application server to provide log entries back to a predetermined date, preferably a date that provides a sufficient log history to assist the IT professional in analyzing the network but not so long as to provide information that is no longer of interest.

Turning back to the “Network Management” menu, the past several menus were under the “NT Server” icon. The next icon on that menu, “Unix Server Admin,” generates the following menu when selected:

Unix Server Groups

WWW Servers
Oracle Prod. Servers
Oracle Dev. Servers
Print Servers
Find Device

. . . Submit

Network Management

BACK

The “Oracle Product Servers” icon generates the following menu when selected:

Oracle Products

ARPROD01
ARPROD02
MKPROD01
MKPROD02
SSPROD01

Unix Groups

BACK

The first screen generated in connection with the selection of a particular product is the functions menu:

ARSRVWWW2

Show Statistics
Manage Processes
Reboot/Shut Down
Activity Log

Unix Groups

BACK

The menus generated in accordance with the above icons are similar to those described for the NT Servers. The statistics, processes, and logs are customized to the Unix products.

Turning now to the final icon on the “Network Management” menu, the “Routers” icon generates the following sample menu:

Router Groups

Bldg 55
Bldg 65
Bldg 85
Dallas
Los Angeles
Miami

Submit

Network Management

BACK

The above screen reflects a computer network where a business has several locations in a particular city (e.g., its headquarters) and several satellite offices in the designated cities. By selecting a particular location (selecting the corresponding icon and confirming by selecting the “Submit” icon), a menu is generated showing the routers at a particular location. Further menus with corresponding functions and actions to be taken in connection with a particular router are available. For example, the following functions can be made part of a router function menu:

CRLAN215

Show Interfaces
Ping Device
Ping From Device
Show Route
Add/Remove Route
Reboot/Shutdown
Activity Log

Router Groups

BACK

It should also be understood that the application server 30 will generate a response screen indicating that a particular function has been performed successfully or unsuccessfully, e.g., in the case of a device ping.

The above menu system is merely an example to illustrate the invention. Those skilled in the art will readily appreciate that menu items can be added or removed as desired and to correspond to the specific network devices and corresponding functions. The goal is to provide common network management functions in an easy-to-use, simplified format.

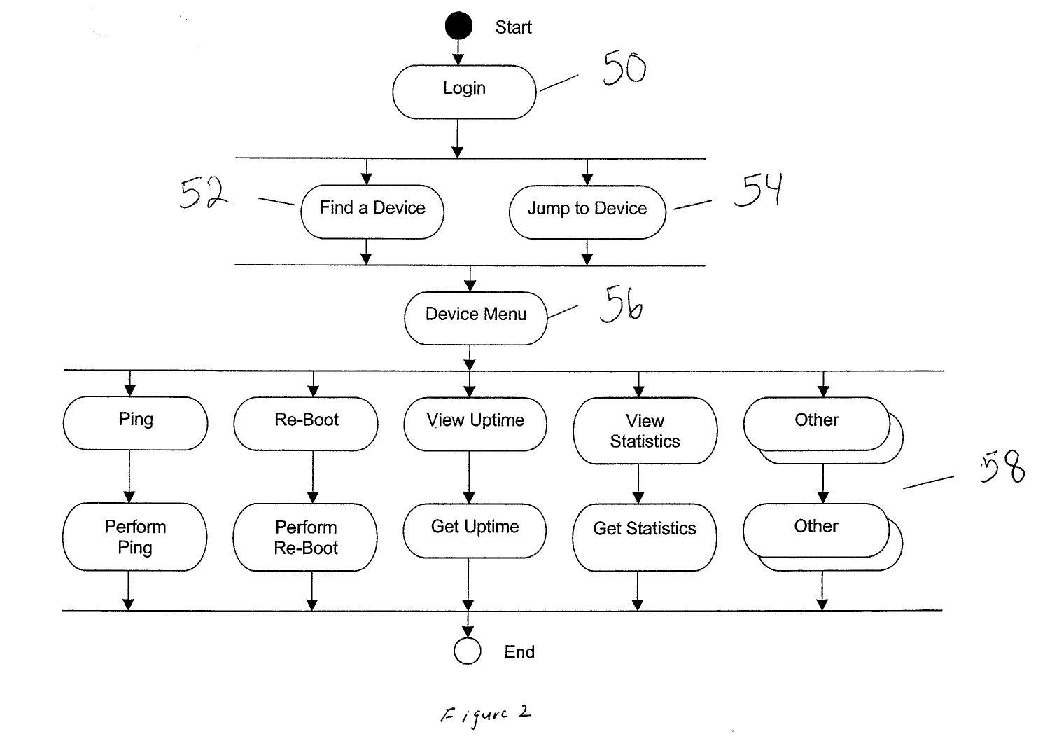

Turning now to the software and methodology for implementing the menu system and its use in connection with wireless devices. FIG. 2 is an activity diagram reflecting the general flow architecture for the system and method. The wireless device will typically have a bookmark or icon dedicated to launching the network management program. As reflected in FIG. 2 at 50, the first screen is the login screen. The user is prompted to input a password. The password serves two purposes: 1) validates the user is authorized to use the system; and 2) determines what permissions or privileges govern the user's capabilities. Although the preferred menu is more detailed, the general architecture is to provide the user with the opportunity to find a network device or application through a series of drill-down selections (e.g., list of selectable devices) and menus, or if the user knows the specific device identifier, e.g., name or IP address, the user can enter and proceed directly to the menus for the device, as shown at 52 and 54, respectively, in FIG. 2. Next, the user is presented with a dynamic menu of functions corresponding to a specific device, as generally designated at 56 in FIG. 2. The contents of a dynamic menu can vary, as explained above. The displayed functions are preferably based on two criteria: 1) the functions specific to and available for a device; and 2) the permissions or privileges corresponding to the user. The first criterion is, of course, mandatory in the sense that a function cannot be effectively provided if the device is not capable of performing the function. The second criterion is optional, but, in systems where there are more than one IT professional responsible for network management, the second criterion ensures that lower level personnel are not able to perform severe network functions or functions that are more appropriately handled by upper-level IT professionals. Note also that dynamic menu content can contain items that never change, i.e., are required in all cases. Examples can include: links to online help text, application navigation methods, display of session variables such as user name or device name, etc. Finally, the user is able to perform a variety of functions on a particular device and the results are transmitted to the user, as reflected at 58 in FIG. 2. Common functions include, but are not limited to:

Statistics—obtain device statistics such as CPU utilization, available disk space, system uptime, etc.

Start/Stop Services—services or processes run continually on computers and can include items such as Web Servers, applications such as PC Anywhere, File Transfer Protocol (FTP), print queue management, e-mail delivery, etc.

Reboot—devices can be shut down, or re-started as a step in resolving or troubleshooting a problem.

Show Interface—network routers have extensive details associated with their configured interfaces.

Show route—a trace route can be performed from a router to another router to determine the network path a connection may take.

Ping—a router can gather statistics as a result of pinging another device. This is a common non-invasive method used during network troubleshooting.

Start database—a database can be started in various modes specific to the database product such as “start without mirroring”, etc.

Stop database—a database can be stopped as a step in problem resolution.

Change Dynamic System Parameters—databases have parameters that govern their behavior and constraints that can be changed and take affect immediately.

Start, Stop, and Refresh SQL*Net Listener—Oracle databases use SQL*Net Listener as a method for communication with external systems (such as MobileLYNX). SQL*Net Listener can be started, stopped, or refreshed as a step in problem resolution.

Coalesce tablespace—database tables can be merged.

Take tablespace offline—database tables can be made temporarily unavailable as a step in problem resolution.

Put tablespace online—database tables can be made available as a step in problem resolution.

Add/Rename/Move a data file—the physical data file of a database can be added, renamed, or moved as a step in problem resolution.

Add/Rename/Move a column—a table column can be added, renamed, or moved as a step in problem resolution.

Add/Rename/Move a table—a table can be added, renamed, or moved as a step in problem resolution.

Show events queue—certain events can be scheduled or initiated by a database, and the current status of those events can be obtained as part of problem troubleshooting.

List background Oracle processes—certain processes can be scheduled or initiated by Oracle, and the current status of those processes can be obtained as part of problem troubleshooting.

Provide SQL interface—a user may enter a Structured Query Language (SQL) command to interrogate an SQL-capable database, and view the results.

View event log—systems can log events and transactions, which the user may display as a step in problem troubleshooting.

These functions are well known to people skilled in the art. It is understood that additional functions may be utilized as well.

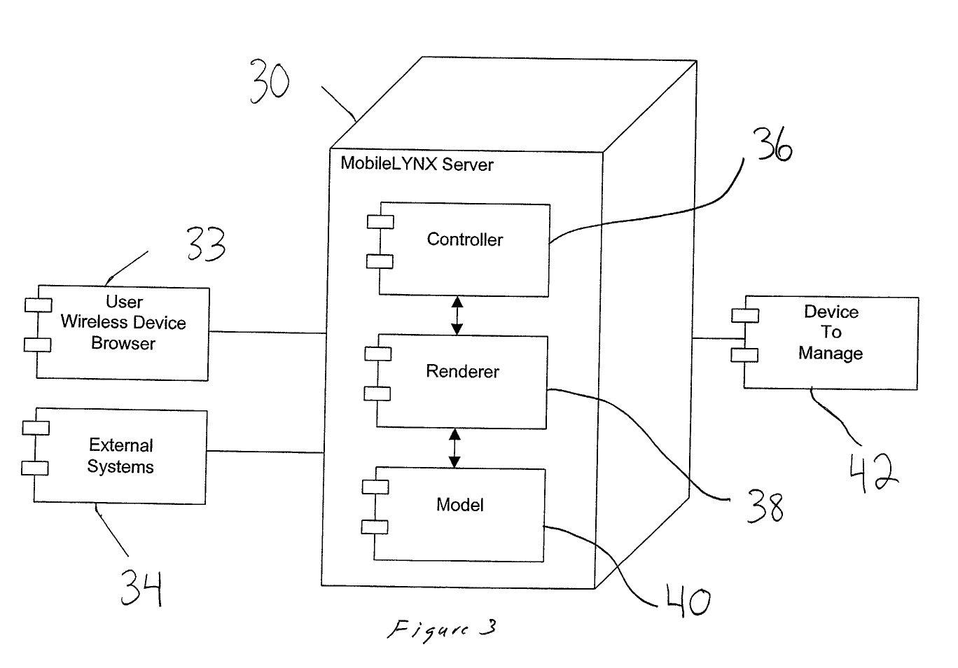

Referring to FIG. 3, a block diagram of the system architecture is depicted. In one aspect of the invention, the wireless device 22 implements the above-described menu system to allow users to remotely manage the computer network. The wireless device is adapted to interface to the application server 30. Common wireless devices include, but are not limited to, WAP-enabled mobile telephones, two-way pagers, and wireless enabled personal digital assistants (PDAs). These devices typically provide a user interface via a browser application 33 that is resident on the wireless device.

In one embodiment, the present invention is adapted to work in conjunction with an external system 34. Examples of such systems include network management systems (e.g., Tivoli, CA Unicenter, Openview), call center management systems (e.g., Remedy), or proprietary systems capable of communicating according to typical system-to-system protocols (e.g., XML-RPC, SOAP, Telnet, SNMP, SMTP). The interface to these types of systems is described in more detail below.

The application server 30 is central to the present invention. It controls communication with the network devices and applications that are to be monitored. The application server 30 includes three primary components: 1) the controller 36; 2) renderers 38; and 3) models 40 corresponding to each renderer. Each of these components is described further below. It should be understood, however, that the present invention is preferably deployed via a software application. The software can be resident on a standalone server or it could be resident on an existing computer network server. Further, the software could even be resident on the wireless device or on the network devices. For example, it is entirely possible to have an agent running on a server and part of the agent includes software to implement the menu user interface. The preferred method and system, however, is to use a standalone server to host the software and serve as the interface between the user and the computer network and the devices that comprise it. Also, it is contemplated that the software of the present invention can be contained on a floppy disk, CD Rom, or delivered to the customer over the Internet. All that is required is a carrier wave to transmit the software to the customer.

In the preferred embodiment, the application server 30 is connected to network devices, generally designated 42, that comprise the computer network. Examples of such devices include Unix servers, Linux servers, Microsoft NT network servers, web servers, Cisco routers, SQL-compliant databases, and Telnet-enabled devices. Communication protocols to the devices include, but are not limited to, Telnet, SNMP, and SOAP.

Turning back to the controller 36, renderers 38 and corresponding models 40, these components act cooperatively as a proxy with the network devices 42 for users that are remote from the computer network. The units collectively comprise the application server 30 and serve to provide the menu (proxy) interface that facilitates network management. The controller 36 is responsible for obtaining connection type context and interaction with the wireless device 22 (or in the event of a non-remote application, a computer terminal or laptop). The controller also determines which of the plurality of renderers to use and passes information to the renderer 38 in accordance with the request from the wireless device 22. After an action or function has been performed on the network device 42, the controller obtains results from the renderer 38 and delivers content to the connection type of the wireless device 22 (e.g., HTTP, WAP, XML-RPC, SNMP).

The renderers 38 are responsible for determining how to present information according to the connection type of the wireless device 22, and thus the renderers are context sensitive. The renderer 38 also instantiates the appropriate method within the models 40 for interacting with the network devices 42. The renderer 38 also sends parameters to the model 40. The renderer 38 is programmed to perform business logic on results received from the device through model 40. The processed results are adjusted for context and sent to the controller 36. The renderer 38 therefore delivers the content to the connection type.

The models 40 correspond to a particular renderer 38 and are associated with a network device 42. A model 40 receives parameters from a renderer 38 and obtains information from the database [#] of the application server 30. The database includes data pertaining to the network devices. The model 40 interacts with the network device 42 and obtains results from the device. The results (success or error) are sent to the associated renderer 38.

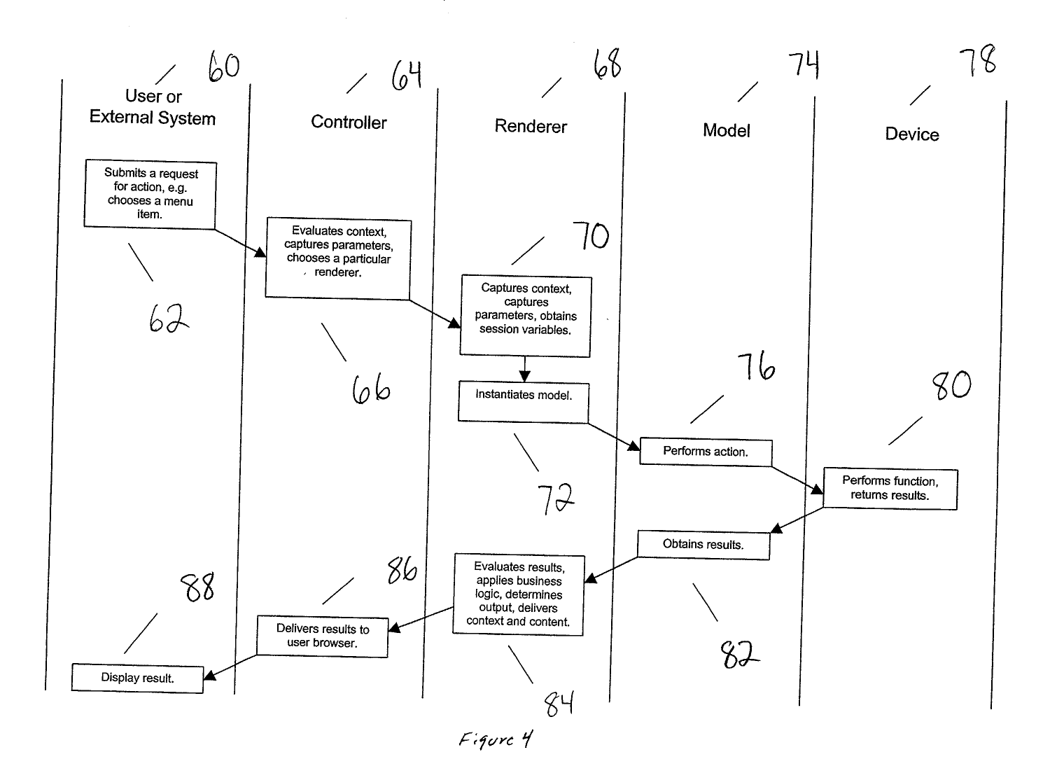

FIG. 4 is a sequence diagram that illustrates the process. The vertical lines define areas of responsibility, or swimlanes, for the various devices and components. At 60, the user or external system is designated. At 62, the user submits a request for an action (preferably by choosing a menu item). At 64, the controller operates in the designated swimlane. The controller evaluates the context of the request from the user (typically a wireless device), captures parameters pertaining to the request, and chooses a particular renderer to perform the request, reflected at 66 in FIG. 4. At 68, the renderer operates in the swimlane. The renderer captures the context of the request from the controller, as well as the parameters required for the designated action, and obtains session variables, as shown at 70. Session variables are maintained by the application server to make the system easier to use. Examples of session variables can include user name, server name, database instance name. Session variables may vary at any given moment depending on the module and function. Session variables are maintained so the user is not required to re-enter information on every screen. At 72, the renderer instantiates the model. At 74, the model operates in the corresponding swimlane and performs the action or request called for by the user (e.g., the wireless device), as shown at 76 in FIG. 4. At 78, the network device operates in corresponding swimlane. The device performs the function called for by the model and returns a result to the model, as reflected at 80. At 82, the model obtains the result from the network device and sends it the renderer. The renderer evaluates the results, applies business logic to the results, determines the appropriate output (e.g., success or failure), and delivers context and content to the controller, as shown at 84. At 86, the controller delivers the results to the user browser that resides on the wireless or other device. The wireless device or computer displays the result at 88.

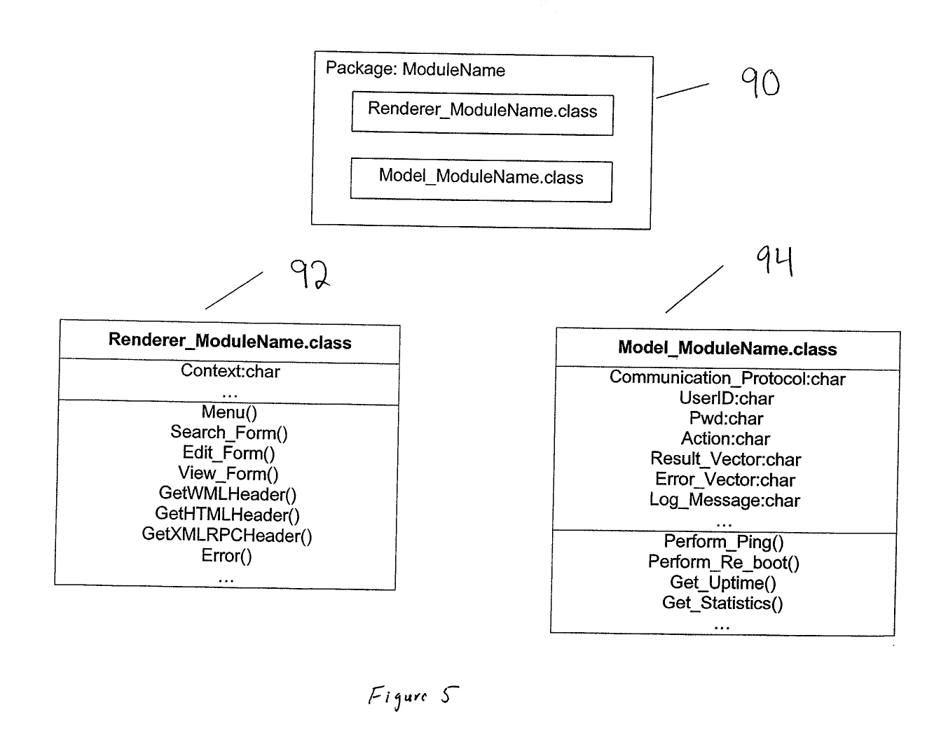

FIG. 5 is a class diagram that further illustrates the renderer/model relationship. For clarity each combination of a renderer and a model is referred to as a module. Each module pertains to a particular device, e.g., a Cisco router, Linux server, and DSLAM. In FIG. 5, “ModuleName” is substituted for the name of a device. As shown at 90, a module is comprised of a renderer and corresponding model. At 92, the “Renderer_ModelName.class is capable of rendering information according to a specific context (e.g., HTTP, WAP, XML). Examples of typical functions are menus, forms, and error messages (a more complete list appears earlier). The functions depicted in the diagram are in the form of xxxo, where xxx is the function to be performed, and () indicate that parameters are to be passed to the function within the parentheses. At 94, the “Model_ModelName.class is capable of interacting with the device irrespective of context. Functions will likely vary by device, such as ping, get statistics, reboot, shut down services, and restart services (described above). The module also may include data stored in the application server database (described below), including attributes such as IP addresses, names, community strings, and associated groups. It should also be understood that programs written in languages native to the device environment (“shims”) can be written to access the device via native application program interfaces (APIs). Examples include DLLs and PERL.

Models 40 are very specific to the device, while the renderer 38 provides the liaison to the device. For example, the user may choose a function from a menu, say, “Restart FTP Service on Server”. Although this is a single request on a menu, it may result in many steps, and it is the renderer's responsibility to determine what those steps are and to assure that those steps are performed by any necessary models successfully (i.e., “business logic”). The renderer may instruct the model to perform:

1. Obtain the address of the desired server from the database

2. Obtain the FTP command for the service on this device from the database

3. Obtain any specific parameters for the FTP service from the database

4. Determine the communication protocol for the server from the database, e.g., Telnet or SNMP.

5. Verify that the desired server is available.

6. Submit the FTP restart command to the desired server.

7. Determine if the FTP restart command has been accepted by the desired server. If not, take remedial action.

8. Determine if the FTP service is being restarted by the desired server. If not, take remedial action.

If successful, the renderer 38 will then format and send a “Successful restart” message to the user device, using the appropriate protocol (HTTP, WAP, etc). During this process, the renderer 38 may choose to use multiple device-specific models, e.g., the “Database” model and the “Server” model. In short, a model must be constructed for every device, which will contain all the functions necessary to interact with the device. A renderer 38 must be constructed to contain all the functions a user may wish to perform on a device. One user function may utilize many models 40, as well as many functions within the models.

As mentioned above, the application server has an internal database in which it stores useful information for its operations. The database scheme below depicts the major tables and their relationships.

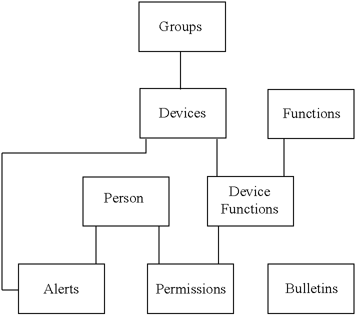

The Groups table allows the user organization to categorize devices. These groups could be defined as geographic, device type, departmental, functional, or any other method the organization chooses. It is the Group table that allows users to use drill-down screens to find a particular device. The Group table contains fields such as:

Group ID (primary key)
Group Name

The Devices table contains all the devices to be managed by the application server. Devices can be hardware, such as servers and routers, or software applications such as Oracle databases. The Devices table contains fields such as:

Device ID (primary key)
Group ID (foreign key)
Device Name
Device Type
Device Address
Login User ID
Login Password

The Functions table contains the functions and default parameters used by devices. The Functions table contains fields such as:

Function ID (primary key)
Function Name
Function Default Parameter

Not all functions are used by all devices. To associate specific functions with specific devices, the Device Functions table is required to cross-reference devices and functions. Likewise, a specific device may require a specific parameter, and this table allows such customization. The Device Function table contains fields such as:

Device ID (compound primary key)
Function ID (compound primary key)
Device Function Parameter

The Person table contains information about the users of the application server. The Person table contains fields such as:

Person ID (primary key)
First Name
Last Name
User ID
Password
Person Type
Phone Number
E-Mail Address
Pager Number
Mail Stop
Department

The Permissions table contains information about which devices and functions the users are allowed to perform. The Permissions table contains fields such as:

Person ID (compound primary key)
Device Function ID (compound primary key)
Permission Level Code

The Alerts table contains information about system alerts. These alerts can be viewed by the users, and also contain links to associated devices so the user can access the device functions directly. The Alerts table contains fields such as:

Alert ID (primary key)
Person ID (foreign key)
Device ID (foreign key)
Device Name
Alert text
Alert timestamp
Alert status

The Bulletins table contains information about general bulletins. The users, to obtain system-wide notifications, can view these bulletins. The Bulletins table contains fields such as:

Bulletin ID
Bulletin Text
Bulletin Submitter
Bulletin Status

The referenced tables and fields are the most significant required by the application server 30. Additional tables can be added to provide additional cross-reference capabilities or improved system performance.

To illustrate the system and method in conjunction with FIG. 4, the following example describes a user logging into the application, finding a router, and displaying the router's statistics. The user turns on the Internet-enabled wireless device 22, and accesses the device's wireless carrier network. Examples include PalmNet, Sprint, OmniSky, and Nextel. The user accesses the wireless application on the wireless device 22. On a WAP-enabled device, this may be a book-marked link on a menu. On a Palm-OS device, it may be an application icon.

The user is presented with a login form, which contains fields for login validation such as user-id and password. The user fills in the fields and posts the data to the application by tapping or clicking the “Submit” button on the screen, as reflected at 62 in FIG. 4. The wireless carrier for transmission through the wireless network encrypts the data. This encryption method is specific to the wireless carrier. The wireless carrier converts the wireless signal to an Internet message in its wireless-internet gateway server. The wireless carrier encrypts the Internet message via SSL, a widely accepted industry de-facto encryption method. The wireless carrier transmits the encrypted Internet message to the application server 30. The application server 30 resides in an organization's “DMZ”, or the cable segment between the router accessing the Internet and the organization's firewall. The application server 30 accepts Internet messages only from the carrier wireless-internet gateway server. All other Internet messages are discarded. This provides a level of access security.

The application server decrypts the message. The application server redirects the Internet message to the application server behind the computer network firewall using a specific and private port. The firewall is configured to allow inbound Internet traffic only from the application server 30 and only on the designated port. This maintains the integrity of the network's segregation of its public IP addresses from its private subnet IP addresses.

The application server 30 receives the Internet message. The controller 36 evaluates the message, determining the context of the message including items such as protocol (e.g., HTTP, WAP), requested action (e.g., login), and associated parameters (e.g., fields such as user identification and password), as reflected at 66 in FIG. 4. The controller 36 determines which renderer 38 is required, instantiates the renderer, and passes the information to the renderer. In this case, the renderer is responsible for the login process.

The renderer 38 validates the user identification and password, as shown at 70 in FIG. 4. The renderer instantiates the model 40. The renderer requests a validation of user identification and password from the model, as reflected at 72. The model looks up the user identification and password in the database and verifies that an exact match exists. The model 40 returns a success code to the renderer 38. The renderer 38 communicates with the model 40 to check the permissions table in the database to ascertain the level of authority the user is allowed. The model 40 accesses the database and returns the user's allowed permission levels to the renderer 38, as reflected at 76 in FIG. 4. The database performs the queries requested by the model 40 and returns the results to the model 40, as shown at 80 in FIG. 4. The model 40 returns the results to the renderer 38, as shown at 82 in FIG. 4. The renderer 38 calls the model 40 to obtain the user's name. The model 40 accesses the database and returns the user's name, as reflected at 76 in FIG. 4. The database performs the queries requested by the model 40 and returns the results to the model, as reflected at 80. The model 40 returns the results to the renderer 38, as shown at 82 in FIG. 4. The renderer 38 stores the information obtained from the model 40 and Internet in session variables for the users.

The renderer 38 formats a response message menu file for the user, using the protocol and user permissions, as shown at 84. The renderer 38 passes the message to the controller 36. The controller 36 transmits the message through the organization's firewall to the application server 30, as shown at 86 in FIG. 4.

The application server 30 encrypts the message using SSL. The application server 30 transmits the message to the user through the Internet. The wireless carrier accepts the message at the carrier wireless-internet gateway server and decrypts it. It immediately encrypts it again for wireless transmission. The wireless carrier transmits the message to the user. The user's device accepts the message, decrypts it, and displays it on the device screen. This is the “Main Menu,” as shown at 88 in FIG. 4.

The “Main Menu” accomplishes the following, it: 1) confirms successful login; and 2) displays a choice of menu items. In this example, the user wants to gather statistics from a particular router in Building 65. The user begins to find the router by choosing “Network Management” on the “Main Menu”. This request for a menu posted to the application, as reflected at 62. The wireless carrier for transmission through the wireless network encrypts the data. This encryption method is specific to the wireless carrier. The wireless carrier converts the wireless signal to an Internet message in its wireless-internet gateway server. The wireless carrier encrypts the Internet message via SSL. The wireless carrier transmits the encrypted Internet message to the application server. The application server resides in an organization's “DMZ”, or the cable segment between the router accessing the Internet and the organization's firewall 28. The application server 30 accepts Internet messages only from the carrier wireless-Internet gateway server. All other Internet messages are discarded. This provides a level of access security. The application server 30 decrypts the message. The application server 30 redirects the Internet message to the application server behind the organization's firewall using a specific and private port.

The application server 30 receives the Internet message. The controller 36 evaluates the message, determining the context of the message including items such as protocol (e.g., HTTP, WAP), requested action (e.g., get_network_management_menu), and associated parameters (e.g., fields such as userid and password), as shown at 66. The controller 36 determines which renderer 38 is required, instantiates the renderer 38, and passes the information to the renderer 38. The renderer 38 is responsible for the “Network Management Menu” process, as shown at 70 in FIG. 4. The renderer 38 instantiates the model 40, as shown at 72 in FIG. 4. The renderer 38 calls the model 40 to determine what network management modules are installed on the application server 30. The model 40 accesses the database according to the criteria given it by the renderer 38, as shown at 76 in FIG. 4.

The database performs the queries requested by the model 40, and returns the results to the model 40, as shown at 80. The renderer 38 formats a response message containing the “Network Management Menu” file for the user, using the protocol and user permissions, as shown at 82 in FIG. 4. The renderer passes the message to the controller 36, as shown at 84. The controller 36 transmits the message through the organization's firewall to the application server 30, as reflected at 86.

The application server 30 encrypts the message using SSL. The application server 30 transmits the message to the user through the Internet. The wireless carrier accepts the message at the carrier wireless-Internet gateway server and decrypts it. It immediately encrypts it again for wireless transmission. The wireless carrier transmits the message to the user. The user's device accepts the message, decrypts it, and displays it on the device, as shown at 88 in FIG. 4. The user is presented with the “Network Management Menu”. On it, the user chooses from groups of routers, in this case “Building 65,” as shown at 62. The wireless carrier for transmission through the wireless network encrypts the data. This encryption method is specific to the wireless carrier. The wireless carrier converts the wireless signal to an Internet message in its wireless-internet gateway server. The wireless carrier encrypts the Internet message via SSL. The wireless carrier transmits the encrypted Internet message to the application server. The application server resides in an organization's “DMZ”, or the cable segment between the router accessing the Internet and the organization's firewall 28. The application server 30 accepts Internet messages only from the carrier wireless-internet gateway server. All other Internet messages are discarded. This provides a level of access security. The application server decrypts the message. The application server redirects the Internet message to the application server behind the organization's firewall 28 using a specific and private port.

The application server 30 receives the Internet message. The controller 36 evaluates the message, determining the context of the message including items such as protocol (e.g., HTTP, WAP), requested action (e.g., get_device_list), and associated parameters (e.g., fields such as GroupName), as reflected at 66 in FIG. 4. The controller 36 determines which renderer 38 is required, instantiates the renderer 38, and passes the information to the renderer 38. The renderer 38 is responsible for the obtaining the devices in the group “Building 65,” as shown at 70 in FIG. 4.

The renderer 38 instantiates the model, as reflected at 72. The renderer 38 calls the model 40 to obtain a list of devices in the “Building 65” group that the user is allowed to manage. The model 40 accesses the database according to the criteria provided by the renderer 38, as reflected at 76. The database performs the queries requested by the model 40 and returns the results to the model, as shown at 80. The model 40 returns the results to the renderer 38, as reflected at 82. The renderer 38 formats a response message containing the “Building 65 Menu” file for the user, using the protocol and user permissions, as shown at 84 in FIG. 4. The renderer 38 passes the message to the controller 36, as shown at 86. The controller 36 transmits the message through the organization's firewall to the application server 30. The application server 30 encrypts the message using SSL.

The application server 30 transmits the message to the user through the Internet. The wireless carrier accepts the message at the carrier wireless-Internet gateway server and decrypts it. It immediately encrypts it again for wireless transmission. The wireless carrier transmits the message to the user. The user's device accepts the message, decrypts it, and displays it on the wireless device, as shown at 88. The user is presented with a list of routers in the “Building 65” group. The user finds the desired router and selects it, as reflected at 62 in FIG. 4. The wireless carrier for transmission through the wireless network encrypts the data. This encryption method is specific to the wireless carrier. The wireless carrier converts the wireless signal to an Internet message in its wireless-Internet gateway server. The wireless carrier encrypts the Internet message via SSL. The wireless carrier transmits the encrypted Internet message to the application server. The application server resides in an organization's “DMZ”, or the cable segment between the router accessing the Internet and the organization's firewall. The application server 30 accepts Internet messages only from the carrier wireless-Internet gateway server. All other Internet messages are discarded. This provides a level of access security.

The application server 30 decrypts the message. The application server 30 redirects the Internet message to the application server behind the organization's firewall 28 using a specific and private port. The application server 30 receives the Internet message. The controller 36 evaluates the message, determining the context of the message including items such as protocol (e.g., HTTP, WAP), requested action (e.g., get router_functions), and associated parameters (e.g., fields such as RouterName), as shown at 66 in FIG. 4. The controller 36 determines which renderer 38 is required, instantiates the renderer 38, and passes the information to the renderer 38. The renderer is responsible for the building the “Router Functions Menu,” as shown at 70. The renderer 38 instantiates the model, as shown at 72. The renderer 38 calls the model to obtain a list of functions for the specified router that the user is allowed to perform. The model 40 accesses the database according to the criteria given it by the renderer 38, as reflected at 76. The database performs the queries requested by the model 40, and returns the results to the model 40, as shown at 80 in FIG. 4. The model 40 returns the results to the renderer 38, as reflected at 82. The renderer 38 formats a response message containing the “Router Functions Menu” file for the user, using the protocol and user permissions, as shown at 84 in FIG. 4. The renderer 38 passes the message to the controller 36, as shown at 86.

The controller 36 transmits the message through the organization's firewall 28 to the application server 30. The application server 30 encrypts the message using SSL. The application server 30 transmits the message to the user through the Internet. The wireless carrier accepts the message at the carrier wireless-Internet gateway server and decrypts it. It immediately encrypts it again for wireless transmission. The wireless carrier transmits the message to the user. The user's device accepts the message, decrypts it, and displays it on the wireless device, as shown at 88 in FIG. 4. The user is presented with a menu of all the functions the user is allowed to perform on the specified router. The user chooses “View Statistics” from the menu, as shown at 62. The wireless carrier for transmission through the wireless network encrypts the data. This encryption method is specific to the wireless carrier. The wireless carrier converts the wireless signal to an Internet message in its wireless-internet gateway server. The wireless carrier encrypts the Internet message via SSL. The wireless carrier transmits the encrypted Internet message to the application server. The application server 30 resides in an organization's “DMZ”, or the cable segment between the router accessing the Internet and the organization's firewall 28. The application server 30 accepts Internet messages only from the carrier wireless-internet gateway server. All other Internet messages are discarded. This provides a level of access security.

The application server 30 decrypts the message. The application server 30 redirects the Internet message to the application server behind the organization's firewall 28 using a specific and private port. The application server 30 receives the Internet message. The controller 36 evaluates the message, determining the context of the message including items such as protocol (e.g., HTTP, WAP), requested action (e.g., get router_statistics), and associated parameters (e.g., fields such as RouterName), as reflected at 66 in FIG. 4. The controller 36 determines which renderer 38 is required, instantiates the renderer, and passes the information to the renderer 38. The renderer 38 is responsible for obtaining “Router Statistics,” as shown at 70. The renderer 38 instantiates the model 40, as shown at 72. The renderer 38 instantiates the router model 40, as reflected at 72. The renderer 38 calls the model to obtain the connection method, login identification, and login password for the specified router. The model 40 accesses the database according to the criteria given it by the renderer 38, as shown at 76 in FIG. 4. The database performs the queries requested by the model 40 and returns the results to the model 40. In this case, the access method 40 is Telnet, as shown at 80.

The model 40 returns the results to the renderer 38, as shown at 82 in FIG. 4. The renderer 38 calls the router model to obtain statistics from the specified router. The router model 40 uses Telnet to log into the router, as shown at 76. The router accepts the Telnet login, as shown at 80. The router model issues a Telnet command to query the router for its statistics, as reflected at 76. The router provides its statistics, as shown at 80. The router model returns the statistics data to the renderer 38, as shown at 82. The renderer 38 formats a response message containing the “Router Statistics” file for the user, using the wireless device protocol, as shown at 84 in FIG. 4. The renderer 38 passes the message to the controller 36, as shown at 86. The controller transmits the message through the organization's firewall 28 to the application server 30.

The application server 30 encrypts the message using SSL. The application server 30 transmits the message to the user through the Internet. The wireless carrier accepts the message at the carrier wireless-Internet gateway server and decrypts it. It immediately encrypts it again for wireless transmission. The wireless carrier transmits the message to the user. The user's device accepts the message, decrypts it, and displays it on the wireless device 22. The user views the router statistics, as shown at 88 in FIG. 4.

In an alternative embodiment, the application server 30 is adapted to work in conjunction with a network management system (NMS), e.g., Tivoli or Openview. In this embodiment, the NMS system monitors the computer network and generates an alert in the event a network condition occurs, typically a problem of some sort. In this embodiment, the application server 30 is connected to the NMS system to receive the alert and the application server forwards the alert to the wireless device 22. The IT professional responds to the alert via the wireless device and the application server communicates with the NMS system to close the alert.

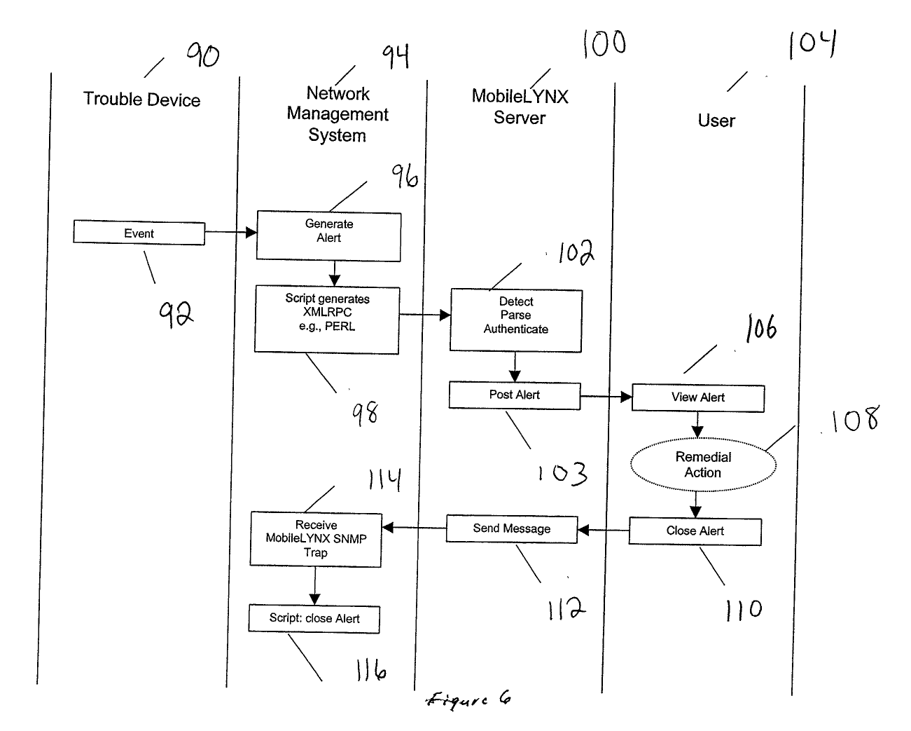

FIG. 6 is a sequence diagram that reflects the process of the application server 30 working in conjunction with an NMS system. At 90, a device experiencing a problem operates in the swimlane. The problematic device generates an SNMP trap as a result of a negative event, as reflected at 92. At 94, the NMS system operates in the swimlane. The NMS system monitors the computer network and detects events. Depending on the event, the NMS will ignore it, log it, or generate an alert. At 96, the scenario under which the NMS system generates an alert is depicted. At 98, the alert triggers a script to generate XML RPC. The script is straightforward and can be written in a variety of languages, e.g. PERL. The XML contains pertinent attributes such as the device name, IP address, problem description, and alert ID number, as reflected at 98. At 100, the application server 30 operates in the swimlane. It detects the incoming XML, parses it, and authenticates that it came from an approved source, as reflected at 102. At 103, the application server 30 posts the alert to its database. At 104, the IT professional/user operates in swimlane, and in conjunction with a wireless device, queries the list of alerts and views the alert, shown at 106. The user performs remedial actions applicable to the network device 42 that are made available by the menu system sent by the application server 30, as reflected at 108. At 110, the user closes the alert. At 112, the application server updates its database and generates any of a number of message types: SNMP trap; network API specific to the NMS system; or proprietary format compatible with a daemon running on a custom NMS platform. Commonly, the application server 30 will generate an SNMP trap. At 114, the NMS system receives the SNMP trap, and triggers a script. At 116, the script closes the alert.

To exemplify the system and method in conjunction with an NMS system, assume that a router experiences an abnormal activity, as reflected at 92 in FIG. 6. The NMS detects the event and, due to the threshold rules configured within the NMS, the NMS generates an alert. As part of the alert, a script is triggered, as shown at 96 in FIG. 6. The script is written in any common scripting languages such as PERL. The script creates an XML document containing pertinent information. Such information can include the timestamp, the router name, assigned technician, the fault description, severity codes, and current status. The XML is transmitted to the application server 30 via a remote procedure call such as XML RPC or SOAP, which are de-facto industry standards for system-to-system interactivity. This event is reflected at 98 in FIG. 6.

The application server 30: 1) detects the incoming remote procedure call; 2) parses the contents of the remote procedure call; and 3) authenticates that the NMS is the authorized source of the remote procedure call. (An attempted remote procedure call from an unauthorized source is logged as an attempted breach and set aside for analysis by system administrators). These events are reflected at 102 in FIG. 6.

The application server 30 logs the alert in its database, using the information contained in the XML document. The alert record is also associated with: 1) the assigned technician (user); and 2) the server in trouble within the database. The associated user information can include a preferred notification code (e.g., no immediate notification, text page, email, etc.) and notification address (e.g., pager number, e-mail address.) The associated server information includes its name, address, connection method (e.g. SNMP, Telnet), and its associated services. These events are reflected at 103 in FIG. 6.

The assigned technician views the alert. The user can proactively view a queue of assigned alerts. In addition, the user can be automatically informed of the alert via a text page or e-mail depending on the capability of the user's wireless device, as reflected at 106 in FIG. 6. The user resolves the problem on the router by viewing the router's statistics to determine if further action is required (described above), as reflected at 108 in FIG. 6. The user closes the alert, indicating the remedy performed, as shown at 110 in FIG. 6.

The application changes the status of the alert in its database to be closed, updating the record with a timestamp, user identification, and remedy code. The application server 30 sends a message to the NMS indicating that the alert has been closed. The format of the message can be any type compatible with the NMS system. A format common to many NMS systems is an SNMP Trap. These events are shown at 112 in FIG. 6. The NMS receives the message, in this case an SNMP trap, from the application server 30 in a routine fashion, i.e., as if the application server is like any other device within the purview of the NMS, as reflected at 114 in FIG. 6. According to the rules configured within the NMS, the NMS responds to the message by closing its alert, as shown at 116 in FIG. 6.

The present invention also includes a secure interface between the application server 30 and wireless devices that remotely access the application server. The security software/firewall 28 is preferably resident on the application server 30. The security focuses on two main issues: encryption (hiding the information being transmitted) and authentication (the user is authorized to use the wireless device 22 and the wireless device 22 is, in fact, communicating with the application server 30 and not another device masquerading as the application server).

Beginning with authentication, access to the application server can be limited to a finite set of users who will have to enter a username and a password to gain access into any part of the system where critical information or critical functions are maintained. Devices such as a cell phone or Palm PDA have a unique serial number that is sent with every transaction. This serial number can be used to limit which devices have access to the application server. To further enhance the authentication process, an RSA SecurID feature is added. The RSA ACE/Server works with RSA SecurID tokens to authenticate the identity of users, granting access only to authorized users on valid RSA ACE/Agents. The agents run on top of the application server 30, as is well known in the art. The RSA SecurID tokens are small, handheld devices containing a microprocessor that calculates and displays unpredictable codes. These codes change at a specified interval, typically 60 seconds. In order to gain access to the system, the user of the device must have the token/card in hand and must also know a secret PIN number assigned to the token/card. This is called Two-factor User authentication because it requires a secret, memorized personal identification number (PIN) and the current code generated by the token assigned to the user. Because the generated code expires after 60 seconds, the code is not reusable, so someone knowing both the PIN and the generated code has only 60 seconds in which to use it. In alternative embodiment, instead of the RSA token, biometrics could be use, e.g., a fingerprint or other DNA identification.

The security system also includes restrictions. When a restriction is placed on the server, this means that access to the server is limited to a set number of people or devices. A restriction by itself does not make a system secure, but adds another layer of security.

A gateway restriction can also be implemented, which restricts the devices from which the application server can accept requests. For example, if a client was using only PalmNet's Network for wireless devices, the application server can be set to accept connections only from PalmNet's gateway.

Server restrictions can also be used. In a dual server configuration, the first server accepts calls from the devices and then forwards the requests to the application server that is protected behind a firewall. The first server can be set to allow only traffic from the PDA's gateway (mentioned above) while the second can be limited to only accept traffic/requests from the first server.

Turning now to the encryption, Secure Socket Layer (SSL) is preferred. A 128-bit SSL Server ID is a digital certificate. A client can present a certificate electronically to prove identity or right to access information online. Users are able to submit sensitive information to the system with the assurance that they are doing business with the application server and not an impostor's “spoof,” and that the information which they are sending is not intercepted or decrypted by a third party. The digital certificate binds the identity of the organization to a pair of electronic keys that can be used to encrypt and sign digital information. A certificate makes it possible to verify someone's claim that they have the right to use a given key, helping to prevent people from using phony keys to impersonate other users. Used in conjunction with encryption, certificates provide a complete security solution, assuring the identity of one or all parties involved in a transaction. A certificate is issued by a trusted third party called a Certification Authority (“CA”). The CA establishes the identity of the people or organizations to which they issue certificates. Once a CA has established an organization's identity, it issues a certificate that contains that organization's public key. SSL provides data encryption, server authentication, message integrity and client authentication.

While a preferred network management system has been described in detail, various modifications, alterations, and changes may be made without departing from the spirit and scope of user interface and system and method for managing a computer network according to the present invention as defined in the appended claims.

What is claimed is:

1. A method of managing at least part of a computer network, the method comprising:
generating an action signal from a wireless device, the action signal corresponding to a desired network management action to be performed in connection with the computer network;
sending the action signal to the computer network and processing the action signal; and
performing the desired network management action on the computer network.

2. The method of claim 1 further comprising obtaining a result pertaining to the desired network management action and sending the result to the wireless device.

3. The method of claim 2 further comprising performing a security clearance procedure prior to sending the action signal to ensure that the desired network management action is authorized.

4. The method of claim 3 wherein the security clearance procedure comprises sending a password from the wireless device to the computer network and verifying that the password corresponds to an authorized entity.

5. The method of claim 4 further comprising encrypting the action signal and password prior to sending the action signal and password and decrypting the action signal and password at the computer network.

6. The method of claim 5 further comprising corresponding the password to a predefined set of authorized actions that an entity is authorized to perform on the computer network and only allowing the authorized actions to be performed by the entity with the corresponding password.

7. The method of claim 6 wherein the authorized set of actions is less than a total number of actions that can be performed on the computer network.

8. The method of claim 7 further comprising generating menus reflecting the predefined set of actions and displaying the menus on the wireless device.

9. The method of claim 1 further comprising displaying a menu system, having a plurality of menus, on the wireless device and the menus comprise lists of selectable network devices and functions corresponding to the network devices.

10. The method of claim 9 further comprising selecting a device and a function from the menus using the wireless device and transmitting a signal corresponding to the device and function to the computer network.

11. The method of claim 10 further comprising performing the function on the network device and transmitting a result pertaining to the function to the wireless device.

12. A wireless device adapted to assist in remotely managing a computer network, the computer network comprising a server, software, and hardware, the wireless device comprising:
a screen for displaying information;
controls for operating the wireless device;
software for causing menus to be displayed on the screen, the menus corresponding to actions pertaining to managing the computer network, wherein the controls can be activated to select a desired network management action; and
a transmitter for transmitting an action signal corresponding to the desired network management action.

13. The wireless device of claim 12 further comprising a receiver for receiving signals from the computer network corresponding to a result pertaining to the desired network management action.

14. A user interface for controlling a computer network, comprising:
a device menu that identifies at least some of the devices that comprise the computer network;
a device selection identifier that allows for selecting one of the devices;
function menus corresponding to the devices, the menus identifying at least some functions that can be performed in connection with the devices;
a function selection identifier corresponding to the function menus that allows for selecting one of the functions, and wherein on entity is able to select one of the devices comprising the computer network and select one of the functions corresponding to the device that is selected; and
a result screen that displays a result corresponding to the function that is selected.

15. The user interface of claim 14 wherein one of the devices comprises a server.

16. The user interface of claim 14 wherein one of the devices comprises a router.

17. The user interface of claim 14 wherein the devices comprise at least one router and at least one server.

18. The user interface of claim 17 wherein the user interface further comprises a main menu that lists options corresponding to alerts, bulletins, activity log, and devices comprising the computer network.

19. The user interface of claim 17 wherein an option corresponding to devices comprising the computer network, when selected, provides a menu corresponding to at least one router and at least one server of the computer network.

20. The user interface of claim 14 wherein the functions comprise statistics and reboot/shutdown.

21. The user interface of claim 20 wherein the functions further comprise manage services and activity log.
